(19) United States
(12) Patent Application Publication
(10) Pub. No.: US 2025/0208982 A1
(43) Pub. Date: Jun. 26, 2025

(54) SYSTEM AND METHOD FOR MANAGING A TEST BENCH FOR A CROSS-DOMAIN TEST

(71) Applicant: WOVEN BY TOYOTA, INC., Tokyo (JP)

(72) Inventors: Brandon FULLJAMES, Tokyo (JP); Beck CHEN, Tokyo (JP); Ming CHEN, Tokyo (JP); Hannah CO, Tokyo (JP); Fredrik LINDEVALL, Tokyo (JP); Anthony SUTERA, Tokyo (JP); Patrick HESPE, Tokyo (JP); Ryo NAKAO, Tokyo (JP); Jake ROONEY, Tokyo (JP); Cyril COURTOY, Palo Alto, CA (US)

(73) Assignee: WOVEN BY TOYOTA, INC., Tokyo (JP)

(21) Appl. No.: 18/394,240

(22) Filed: Dec. 22, 2023

(51) Int. Cl. G06F 11/36

(52) U.S. Cl. CPC G06F 11/3684

(57) ABSTRACT

Provided are a system, method, and device for facilitating provisioning and/or utilization of a test bench for a cross-domain test for testing software of an embedded system. According to embodiments, the method may be implemented by at least one processor and may include: obtaining a test bench configuration associated with the software; obtaining information of a plurality of test artifacts associated with the test bench configuration; and generating, based on the plurality of test artifacts, a test bench associated with the cross-domain test, wherein the software of the embedded system comprises an in-vehicle electronic control unit (ECU).

### TECHNICAL FIELD

Systems and methods consistent with example embodiments of the present disclosure relate to test bench management, and more particularly, relate to systems and methods for facilitating provisioning and utilizing one or more test benches for a cross-domain test.

### BACKGROUND

A test bench in software testing may refer to information or parameters, such as a set of tools, procedures, functional compositions, fixtures, or the like, which, when being compiled or utilized, enable a testing to be performed in a desired condition, environment, or configuration.

In some circumstances, a test bench may provide or define various test requirements, such as hardware resources and/or software resources required for providing a virtual environment that simulates the actual environment where the software will be deployed and be tested, amongst others.

The resources used in a test bench for software testing may include requirements on hardware resources, such as requirement on hardware components with which the software may interact in order for the software to function properly. For example, in the context of vehicle embedded system, the hardware resources may include one or more physical electronic control units (ECUs) with which a target ECU (e.g., ECU under test) interoperate, one or more servers in which associated data or information are hosted, and/or the like. In addition to hardware resources, a test bench for software testing may also include requirements on software resources. For example, in the context of vehicle embedded system, the software resources may include one or more virtualized or emulated ECUs with which the target ECU interoperate, one or more operating systems for executing the test, and/or the like.

Simply put, the relationship between a test bench and resources in software testing is that the test bench provides or defines the resources needed to execute the testing and evaluate the performance of the software under various conditions. By simulating the actual environment or conditions in which the software will be deployed, the test bench helps to identify and address any issues or defects in the software, to verify the correctness of soundness of a design of the software, or the like, before the software is deployed in the actual production environment. This helps to ensure that the software is reliable, performs well, and meets the requirements.

In this regard, the resources required for testing depend on the nature of the software being tested and the specific test requirements. For example, if the software being tested requires a specific operating system or a specific hardware configuration, then the test bench would be required to include information of said resources in order to effectively test the software. Additionally, the test bench is required to be designed to accommodate the specific type of test(s) to-be performed, such as a single level testing, a multi-level testing, or the like. By way of example, a test bench associated with a software-in-the-loop (SIL) test environment may be different from a test bench associated with a hardware-in-the-loop (HIL) test environment.

In view of the above, the test bench is required to be carefully configured and designed, in order to ensure efficient and effective testing. Nevertheless, as described in the following, the provisioning and utilization of test benches for testing vehicle-related software in the related is limited, inefficient, and ineffective.

To begin with, in the related art, whenever a testing of a software component involves a specific hardware component (e.g., a specific physical ECU, etc.), the user is required to visit a specific testing facility in which the specific hardware component is deployed, to couple the software component to said hardware component, to configure the test bench(s) accordingly, and to perform the testing thereafter. Thus, accessing and utilizing test bench(s) is time consuming, since the user(s) is required to physically travelling to the specific testing facility before being able to access the test bench(s).

Further, since the hardware being deployed in the testing facility is limited and is restricted to specific type or variant, the number of possible parallel testing is low, building or configuring a test bench(s) on the spot is challenging, and a test bench(s) built for a specific vehicle variant cannot be utilized for other vehicle variants.

For instance, since the hardware resources of the testing facility are physically fixed and are deployed in a black-box manner (e.g., a user utilizing the testing facility may reserve most of (if not all of) the resources in the testing facility) whenever a testing is in progress, it is unduly difficult (if not impossible) for multiple users to utilize the testing facility at the same time, and it is also difficult (if not impossible) for a user to utilize the testing facility to simultaneously perform multiple testing. Thus, whenever a user has multiple testing to-be performed, and/or whenever multiple users would like to utilize the testing facility, an issue of job collision may occur and the user(s) would need to take turns (place a reservation in a waiting-list, etc.). This, however, would significantly delay the testing and eventually delay the development of the software (e.g., ECU, etc.). Further, the arrangement and coordination among users and testing are being managed manually, which is inefficient and burdensome for the users.

Further, whenever a specific software component (e.g., a specific type of virtual ECU, a specific operating system, etc.) is required but is not available in the testing facility, the user need to make a request to the manager of the testing facility for obtaining the specific software component, the manager need to search for the requested software component and to obtain the same thereafter. This will not only cause further delay in the software testing, but will also incur additional costs (in terms of human resources, fees being charged for obtaining the required software component, and the like).

Furthermore, the test bench(s) is typically deployed and provided in the testing facility, and in most of the situations, is predefined and generic. Accordingly, the user(s) may need to frequently configure the test bench(s) in order to accommodate the intended testing requirements. Nevertheless, in the related art, the user(s) is required to manually configure the provided test bench(s), which is time consuming and may require the user(s) to have good technical understanding on the system in order to appropriately configure the test bench(s). In this regard, a user(s) that do not have good understanding or experience in configuring the test bench(s) may not be able to efficiently and accurately configure the test bench(s), and may render the testing inaccurate and introduce human errors.

The provisioning and utilization of a test bench become more challenging and complex when involving a cross-domain test, which is a testing required in developing advanced or complex features in the vehicle system (e.g., Lane Change Assist, Mobile Smart Keys, etc.). This is because, the cross-domain test involves testing of multiple software components and hardware components across multiple systems, which in turn involves significant numbers of components, users/stakeholders, test requirements, and the like, that increase the dynamic nature in test bench configuration and the required resources for executing the cross-domain test.

In the related art, it is unduly challenging to appropriately and dynamically provide a test bench(s) for reserving the resources for a cross-domain test. Instead, a significant amount of time is required for collecting the required information and for arranging the required software components/hardware components, before the test bench(s) can be configured. Thus, it is time-consuming to prepare and perform the cross-domain test. Further, whenever a change(s) (e.g., update in the software under test, failure in a hardware component, etc.) occurs during the cross-domain test, the test bench(s) is required to be re-designed or re-configured, which may further delay the testing and eventually delay the development of the software. Furthermore, resources being reserved for the cross-domain test may be overprovisioning (which may cause wasted of resources) or under-provisioning (which may cause inefficient test execution and lead to further delay of software development), since the requirements in resources may be dynamic and may continuously (or occasionally) vary.

In view of the above, the approaches for provisioning and utilizing a test bench(s) for a cross-domain test in the related art is restricted, inefficient, and burdensome for the users. Ultimately, these may result in long lead time from system on chip (SoC) specification to vehicle start of production (SOP).

### SUMMARY

According to embodiments, methods, systems, and devices are provided for automatically managing one or more test benches for a cross-domain test for testing one or more software of a system. Specifically, methods, systems, apparatuses, or the like, of example embodiments may automatically obtain required information and automatically provide one or more test benches as per requirements.

According to embodiments, a method for managing a test bench for a cross-domain test for testing software of an embedded system may be provided. The method may be implemented by at least one processor of a system and may include: obtaining a test bench configuration associated with the software; obtaining information of a plurality of test artifacts associated with the test bench configuration; and generating, based on the plurality of test artifacts, a test bench associated with the cross-domain test.

According to embodiments, the obtaining the test bench configuration may include: receiving, from a user, one or more inputs defining the test bench; obtaining a components catalog including information of available test artifacts; determining, based on the one or more inputs and from among the available test artifacts, one or more test artifacts associated with the user-defined test bench; and building, based on the determined one or more test artifacts, the test bench configuration.

According to embodiments, the software of the embedded system may include an in-vehicle electronic control unit (ECU). Further, the plurality of test artifacts may include at least one software component, at least one hardware component, or a combination thereof. The at least one software component may include at least one virtual ECU, at least one emulated ECU, or a vehicle-related model, and the at least one hardware component may include at least one physical ECU. Furthermore, at least a portion of the plurality of test artifacts may be deployed at different geographical locations.

According to embodiments, the method may further include: deploying, based on the test bench, the at least one software component; reserving, based on the test bench, the at least one hardware component; and creating, based on the at least one software component and the at least one hardware component, a virtual vehicle model. According to embodiments, the method may further include generating, based on the virtual vehicle model, a test rig for the cross-domain test.

According to embodiments, the deploying the at least one software component may include: determining, based on the test bench, at least one resource requirement for deploying the at least one software component; determining, from among a plurality of nodes communicatively coupled to the system, at least one node which satisfies the at least one resource requirement; and deploying the at least one software component on the determined at least one node.

According to embodiments, the reserving the at least one hardware component may include: determining, based on the test bench, at least one hardware resource requirement; determining, from among a plurality of hardware components communicatively coupled to the system, the at least one hardware component, wherein the at least one hardware component satisfies the at least one hardware resource requirement; and reserving the at least one hardware component.

According to embodiments, the creating the virtual vehicle model may include: determining, based on the test bench, a relationship among the at least one software component and the at least one hardware component; and connecting, based on the determined relationship, the at least one software component to the at least one hardware component.

According to embodiments, a system for managing a test bench for a cross-domain test for testing software of an embedded system may be provided. The system may include: at least one memory storage storing computer-executable instructions; and at least one processor communicatively coupled to the at least one memory storage and configured to execute the computer-executable instructions to: obtain a test bench configuration associated with the software; obtain information of a plurality of test artifacts associated with the test bench configuration; and generate, based on the plurality of test artifacts, a test bench associated with the cross-domain test.

According to embodiments, the at least one processor may be configured to execute the computer-executable instructions to obtain the test bench configuration by: receiving, from a user, one or more inputs defining the test bench; obtaining a components catalog including information of available test artifacts; determining, based on the one or more inputs and from among the available test artifacts, one or more test artifacts associated with the user-defined test bench; and building, based on the determined one or more test artifacts, the test bench configuration.

According to embodiments, the software of the embedded system may include an in-vehicle electronic control unit (ECU). Further, the plurality of test artifacts may include at least one software component, at least one hardware component, or a combination thereof. The at least one software component may include at least one virtual ECU, at least one emulated ECU, or a vehicle-related model, and the at least one hardware component may include at least one physical ECU. Furthermore, at least a portion of the plurality of test artifacts may be deployed at different geographical locations.

According to embodiments, the at least one processor may be further configured to execute the computer-executable instructions to: deploy, based on the test bench, the at least one software component; reserve, based on the test bench, the at least one hardware component; and create, based on the at least one software component and the at least one hardware component, a virtual vehicle model. Further, the at least one processor may be further configured to execute the computer-executable instructions to generate, based on the virtual vehicle model, a test rig for the cross-domain test.

According to embodiments, the at least one processor may be configured to execute the computer-executable instructions to deploy the at least one software component by: determining, based on the test bench, at least one resource requirement for deploying the at least one software component; determining, from among a plurality of nodes communicatively coupled to the system, at least one node which satisfies the at least one resource requirement; and deploying the at least one software component on the determined at least one node.

According to embodiments, the at least one processor may be configured to execute the computer-executable instructions to reserve the at least one hardware component by: determining, based on the test bench, at least one hardware resource requirement; determining, from among a plurality of hardware components communicatively coupled to the system, the at least one hardware component, wherein the at least one hardware component satisfies the at least one hardware resource requirement; and reserving the at least one hardware component.

According to embodiments, the at least one processor may be configured to execute the computer-executable instructions to create the virtual vehicle model by: determining, based on the test bench, a relationship among the at least one software component and the at least one hardware component; and connecting, based on the determined relationship, the at least one software component to the at least one hardware component.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of an example system architecture for managing a test bench for a cross-domain test, according to one or more embodiments;

FIG. 2 illustrates a block diagram of example components of a test bench management system, according to one or more embodiments;

FIG. 3 illustrates a flow diagram of an example method for facilitating provisioning of a test bench for a cross-domain test, according to one or more embodiments;

FIG. 4 illustrates a flow diagram of an example method for creating a virtual vehicle model, according to one or more embodiments; and

FIG. 5 illustrates a block diagram of an example test rig, according to one or more embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Example embodiments consistent with the present disclosure provide methods, systems, and apparatuses for facilitating provisioning and/or utilization of at least one test bench for a cross-domain test for testing one or more software of an embedded system, such as one or more in-vehicle ECU.

Specifically, methods, systems, apparatuses, or the like, of example embodiments may automatically provide one or more test benches as per requirements. For instance, methods, systems, apparatuses, or the like, of example embodiments may automatically obtain one or more test bench configurations and may automatically generate one or more test benches based thereon. The one or more test bench configurations may be associated with one or more user inputs defining the intended test bench, such as the required software components and/or required hardware components for testing a specific software, or the like.

The generated one or more test benches may be provided to one or more utilization parties for further utilization to perform a cross-domain test. Alternatively or additionally, methods, systems, apparatuses, or the like, of example embodiments may automatically create a virtual vehicle model based on the generated one or more test benches, and may utilize the virtual vehicle model to perform the cross-domain test. In some implementations, one or more test rigs may be generated based on the virtual vehicle model and the generated one or more test benches, and the one or more test rigs may be provided or be utilized for the cross-domain test.

Accordingly, methods, systems, apparatuses, or the like, of example embodiments may continuously (or periodically) monitor status of available test artifacts and resources, and may appropriate generate and reconfigure the one or more test benches when required, based on the real-time or near real-time status and test requirements. As a result, one or more test benches may be provided and be utilized on-demand, without geographical restrictions.

To this end, a user(s) may remotely configure one or more conditions for defining the requirements for performing a cross-domain test, and the required test bench(s) may be automatically and appropriately provided and configured in real-time or near real-time, without requiring the user(s) to physically visit a testing facility. Ultimately, example embodiments of the present disclosure enable the development of the software to be performed more efficiently, the burden of the users may be significantly reduced, the development time may be significantly reduced, and the cost and efforts for planning physical visit or travelling plan to physical testing facility may be significantly reduced.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

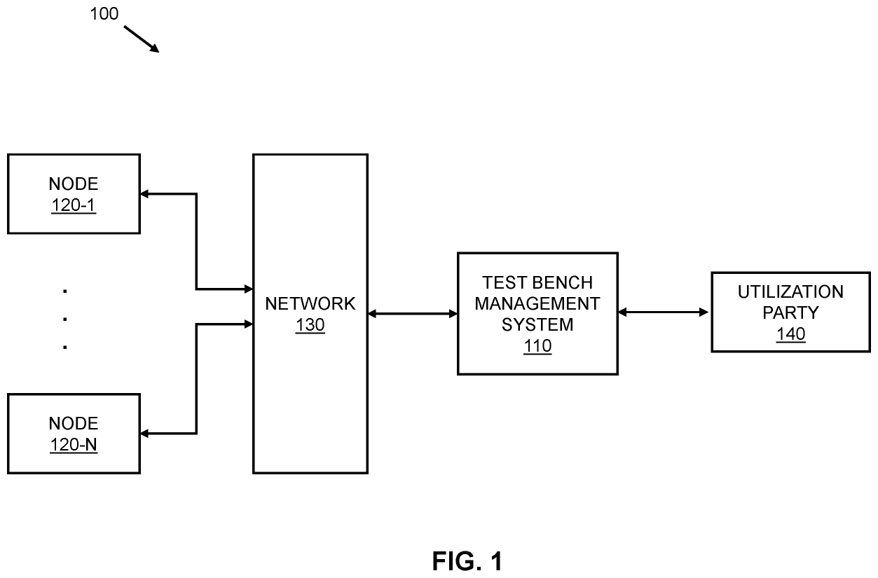

FIG. 1 illustrates a block diagram of an example system architecture 100 for managing (e.g., providing, utilizing, etc.) a test bench for a cross-domain test, according to one or more embodiments. As illustrated in FIG. 1, system architecture 100 may include a test bench management system 110, a plurality of nodes 120-1 to 120-N, a network 130, and at least one utilization party 140.

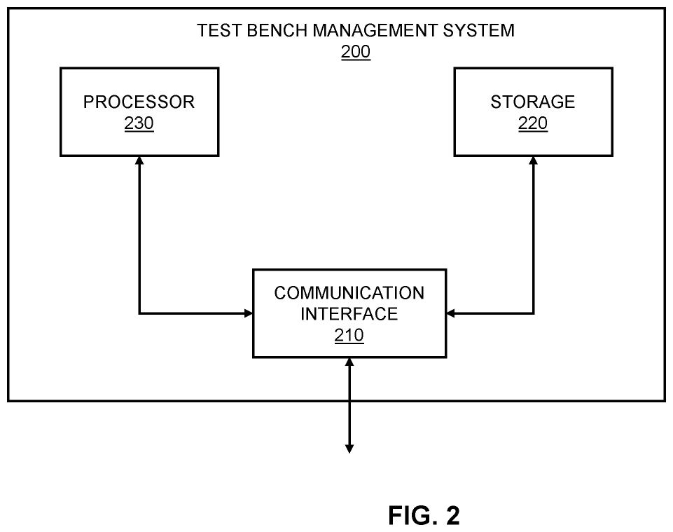

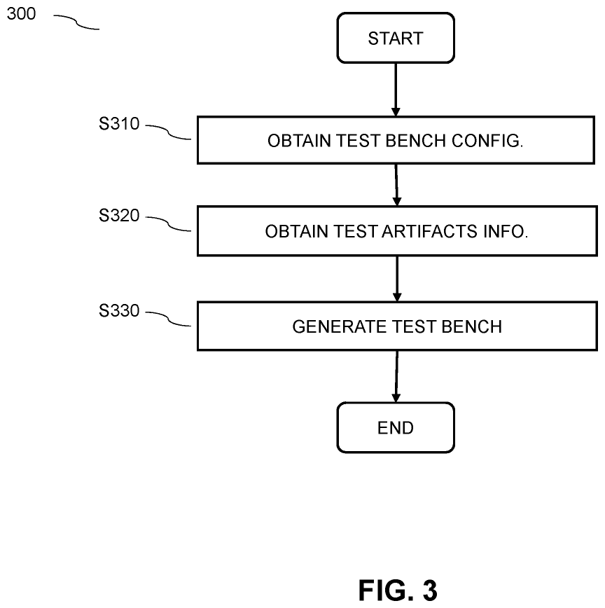

In general, the test bench management system 110 may be communicatively coupled to the plurality of nodes 120-1 to 120-N (via the network 130) and to the utilization party 140, and may be configured to interoperate with the plurality of nodes 120-1 to 120-N to provide a test bench (or one or more associated information or data) to the utilization party 140. Descriptions of example components which may be included in the test bench management system 110 are provided in below with reference to FIG. 2, and one or more operations performable by the test bench management system 110, as well as the associated use cases, are provided in below with reference to FIG. 3 to FIG. 5.

Each of the plurality of nodes 120-1 to 120-N may include one or more devices, equipment, systems, or any other suitable components which may be configured to receive, host, store, deploy, process, provide or the like, one or more artifacts or components which constitute a test bench.

For instance, the node 120-1 may include a device or an equipment (e.g., a personal computer, a server or a server cluster, a workstation, etc.) which may be utilized for building, storing, executing, simulating, executing, or the like, one or more computer executable software applications, such as one or more virtualized ECUs, one or more emulated ECUs, and/or any other suitable software-based components (e.g., vehicle model, Data Communications Module (DCM) model, Heating, Ventilation, and Air Conditioning (HVAC) model, etc.), of a vehicle system. As another example, the node 120-1 may include one or more hardware components, such as one or more fully developed physical ECUs, one or more partially developed physical ECUs, one or more vehicle hardware (e.g., powertrain, engine, etc.), or the like.

According to embodiments, one or more of the plurality of nodes 120-1 to 120-N may include one or more interfaces, each of which may be configured to communicatively coupled the associated node to the test bench management system 110. For instance, the one or more of the plurality of nodes may include a hardware interface, a software interface (e.g., a programmatic interface, application program interface (API), etc.), and/or the like.

According to embodiments, at least a portion of the plurality of nodes 120-1 to 120-N may be located at a geographical location different from the test bench management system 110, different from another portion of the plurality of nodes, and/or different from the utilization party 140.

The network 130 may include one or more wired and/or wireless networks, which may be configured to couple the plurality of nodes 120-1 to 120-N to the test bench management system 110. For example, the network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

According to embodiments, the network 130 may include a virtual network, which may include one or more physical network components (e.g., Ethernet, WiFi module, telecommunication network hardware, etc.) with one or more virtualized network functions (e.g., a control area network (CAN) bus, etc.) implemented therein. Additionally or alternatively, the network 130 may include at least one parameters network. According to embodiments, the network 130 may also be configured to couple the test bench management system 110 (or one or more components included therein) to other components, such as to the utilization party 140, to a plurality of test environments, to one or more devices or equipment of a user (e.g., a tester, etc.), or the like.

The utilization party 140 may include one or more systems, devices, or the like, which may be configured to utilize one or more information or data provided by the test bench management system 110. According to embodiments, the utilization party 140 may include a test management system which may receive one or more test benches (or the associated information or data) from the test bench management system 110 and may utilize the one or more test benches in managing one or more testing (e.g., scheduling a test, triggering a test execution, etc.).

Additionally or alternatively, the utilization party 140 may include at least one software-based test environment (e.g., software-in-the-loop (SIL) test environment, virtual ECU (V-ECU) test environment, model-in-the-loop (MIL) test environment, processor-in-the-loop (PIL) test environment, etc.) and/or at least one hardware-based test environment (e.g., hardware-in-the-loop (HIL) test environment, etc.), which may utilize one or more test benches provided by the test bench management system 110 in performing one or more testing. According to embodiments, at least a portion of the nodes 120-1 to 120-N is associated with at least a portion of said test environments of the utilization party 140. For instance, in the case of the utilization party 140 including a software-based test environment, said utilization party may be hosted or deployed in the portion of the nodes 120-1 to 120-N at which the software-based components or artifacts are deployed. Alternatively or additionally, in the case of the utilization party 140 including a hardware-based test environment, said utilization party may be communicatively coupled (via wireless and/or wired connection) to the portion of the nodes 120-1 to 120-N which are associated with the hardware-based components or artifacts.

Further, the utilization party 140 may also include one or more storage mediums, such as a server or a server cluster, which may be configured to store, publish, or the like, one or more test benches (or information associated therewith) provided by the test bench management system 110.

Referring next to FIG. 2, which illustrates a block diagram of example components of a test bench management system 200, according to one or more embodiments. Test bench management system 200 may corresponds to the test bench management system 110 described above with reference to FIG. 1, thus the features described herein with reference to systems 110 and 200 may be applicable to one another, unless being explicitly described otherwise.

As illustrated in FIG. 2, the test bench management system 200 may include at least one communication interface 210, at least one storage 220, and at least one processor 230, although it can be understood that the test bench management system 200 may include more or less components than as illustrated, and/or the components included therein may be arranged in any a manner different from as illustrated, without departing from the scope of the present disclosure.

The communication interface 210 may include a transceiver-like component (e.g., a transceiver, a separate receiver and transmitter, etc.) that enables the test bench management system 200 (or one or more components included therein) to communicate with one or more components external to the test bench management system 200, such as via a wired connection, a wireless connection, or a combination of wired and wireless connections. For instance, the communication interface 210 may couple the test bench management system 200 (or one or more components included therein) to a plurality of nodes (e.g., nodes 120-1 to 120-N in FIG. 1, etc.) to thereby enable them to communicate and to interoperate with each. As another example, the communication interface 210 may enable the components of the test bench management system 200 to communicate with each other. For instance, the communication interface 210 may couple the storage 220 to the processor 230 to thereby enable them to communicate and to interoperate with each other.

According to embodiments, the communication interface 210 may include a hardware-based interface, such as a bus interface, an Ethernet interface, an optical interface, a coaxial interface, an infrared interface, a radio frequency (RF) interface, a universal serial bus (USB) interface, a Wi-Fi interface, a cellular network interface, a software interface, or the like. According to embodiments, communication interface 210 may include at least one controller area network (CAN) bus configurable to communicatively couple the components of the test bench management system 200 (e.g., storage 220, processor 230, etc.) to a plurality of nodes (e.g., nodes 120-1 to 120-N) and/or to at least one utilization party (e.g., utilization party 140). Additionally or alternatively, the communication interface 210 may include a software-based interface, such as an application programming interface (API), a virtualized network interface (e.g., virtualized CAN bus, etc.), or the like.

According to embodiments, the communication interface 210 may be configured to receive information from one or more components external to the test bench management system 200 and to provide the same to the processor 230 for further processing and/or to the storage 220 for storing. For instance, the communication interface 210 may fetch a real-time or near real-time status of a task, get logs associated with the task, monitor health status of a virtual vehicle (to be further discussed in below), enable one or more interactions among one or more users with the virtual vehicle and the testing environments, and the like.

The at least one storage 220 may include one or more storage mediums suitable for storing data, information, and/or computer-readable/computer-executable instructions therein. According to embodiments, the storage 220 may include a random access memory (RAM), a read only memory (ROM), and/or another type of dynamic or static storage device (e.g., a flash memory, a magnetic memory, and/or an optical memory) that stores information and/or instructions for use by the processor 230.

Additionally or alternatively, the storage 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage 220 may act as a centralized library and may be configured to store information to-be utilized by the processor 230 for facilitating provisioning and/or utilization of a test bench for a cross-domain test. For instance, the storage 220 may be configured to store one or more test bench parameters or configurations predefined or predetermined by one or more users, such as one or more test conditions, information of one or more required software components/hardware components, or the like. Further, the storage 220 may be configured to store one or more test artifacts, components, resources information, and/or the like, which constitute the test bench. Furthermore, the storage 220 may store computer-readable instructions which, when being executed by one or more processors (e.g., processor 230), causes the one or more processors to perform one or more actions or operations described herein.

The at least one processor 230 may include one or more processors capable of being programmed to perform a function or an operation for facilitating provisioning of a cross-domain test. For instance, the processor 230 may be configured to execute computer-readable instructions stored in a storage medium (e.g., storage 220, etc.) to thereby perform one or more actions or one or more operations described herein.

According to embodiments, the processor 230 may be configured to receive (e.g., via the communication interface 210, etc.) one or more signals defining one or more instructions for performing one or more operations. Further, the processor 230 may be implemented in hardware, firmware, or a combination of hardware and software. The processor 230 may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing or computing component.

According to embodiments, the processor 230 may be configured to execute computer-executable instructions stored in at least one memory storage (e.g., storage 220) to thereby perform one or more operations for facilitating provisioning and/or utilization of one or more test benches.

Referring to FIG. 3, which illustrates a flow diagram of an example method 300 for facilitating provisioning of a test bench for a cross-domain test, according to one or more embodiments. One or more operations of method 300 may be performed by at least one processor (e.g., processor 230) of the test bench management system for facilitating provisioning of a test bench for a cross-domain test for testing one or more software associated with an embedded system of a vehicle (e.g., one or more in-vehicle ECU, etc.). It can be understood that the at least one processor may be configured to perform one or more operations of method 300 for updating or reconfiguring one or more test benches, in a similar manner as described herein.

According to embodiments, method 300 may be triggered in response to detection of a change (e.g., an update, etc.) in the one or more software under test. Similarly, method 300 may be triggered in response to detection of a change in the resources, such as detection of a resource which may improve the testing performance, detection of a failure (or a possible unavailability) of a hardware component, or the like.

Referring to FIG. 3, at operation S310, the at least one processor of the test bench management system may be configured to obtain one or more test bench configurations associated with the one or more software under test. The one or more test bench configurations may include information defining a test bench, such as (but are not limited to) software resources and/or hardware resources (e.g., software-based/hardware-based ECUs, computing power, memory, operating system, etc.) to be utilized or be reserved for the test bench, test components/artifacts associated with the testing, the relationship and connection between the test artifacts, type of test environments associated with the testing, one or more test conditions, one or more test procedures, vehicle variant, vehicle communication specification, and/or any other suitable information.

According to embodiments, the at least one processor may be configured to obtain the one or more test bench configurations by: receiving, from one or more users, one or more inputs defining a test bench; obtaining a components catalog including information of available test artifacts or test components; determining, based on the one or more inputs and from among the available test artifacts, one or more test artifacts associated with the user-defined test bench; and building, based on the determined one or more test artifacts, the one or more test bench configurations.

In some implementations, the at least one processor may obtain the one or more test bench configurations in real-time or near real-time, based on one or more user inputs provided by the one or more users. For instance, the at least one processor may receive, from one or more user equipment and via a communication interface (e.g., communication interface 210) of the test bench management system, the one or more inputs defining the test bench, and may build the one or more test bench configurations based thereon on-the-fly.

Additionally or alternatively, the one or more test bench configurations may pre-built or pre-defined, and may be stored in one or more storage mediums (e.g., storage 220 of the test bench management system, storage server external to the test bench management system, etc.). In some implementations, the one or more test bench configurations may be pre-defined by a first user, and the at least one processor may determine that said one or more test bench configurations may be suitable for a second user (e.g., based on determining that the second user is associated with the first user, based on determining that the testing intended by the second user is associated with the testing intended by the first user, etc.). Accordingly, at operation S310, the at least one processor may access the one or more storage mediums (e.g., via the communication interface) and may obtain the one or more test bench configurations therefrom.

Referring still to FIG. 3, upon obtaining the one or more test bench configurations, method 300 may proceed to operation S320, at which the at least one processor of the test bench management system may be configured to obtain information of a plurality of test artifacts associated with the one or more test bench configurations. According to embodiments, the plurality of test artifacts may include at least one software component (e.g., virtualized ECU, vehicle related model, etc.), at least one hardware component (e.g., physical ECU, etc.), or a combination thereof. The information of the plurality of test artifacts may include the availability of the test artifact(s), the location at which the test artifact(s) is deployed or located, the access link associated with the test artifact(s), and/or any other suitable information.

In some implementation, the at least one processor may be configured to obtain, in real-time or near real-time, the information of the plurality of test artifacts from one or more nodes communicatively coupled to the test bench management system (e.g., nodes 120-1 to 120-N). Additionally or alternatively, the information of the plurality of test artifacts may be pre-obtained by the at least one processor and may be stored in the one or more storage mediums. In that case, at operation S320, the at least one processor may access the one or more storage mediums (e.g., via the communication interface) and may obtain the information of the plurality of test artifacts therefrom.

Referring still to FIG. 3, upon obtaining the information of the plurality of test artifacts, method 300 may proceed to operation S330, at which the at least one processor of the test bench management system may be configured to generate a test bench based on the information of the plurality of test artifacts and the obtained test bench configuration(s).

To this end, the at least one processor of the test bench management system may automatically and dynamically facilitate provisioning of one or more test benches for a testing (e.g., a cross-domain test) when required.

Upon generating the one or more test benches, the at least one processor of the test bench management system may be configured to utilize the generated one or more test benches.

According to embodiments, the at least one processor may provide the one or more test benches to a test management system for further processing. For instance, the test management system may be configured to utilize the one or more test benches for executing one or more testing (e.g., cross-domain test). In this regard, it can be understood that, in some implementations, the test bench management system may also be configured to perform one or more operations performable by the test management system described herein, without departing from the scope of the present disclosure.

According to embodiments, the at least one processor of the test bench management system may be configured to store the generated one or more test benches in one or more storage mediums, such as a storage (e.g., storage 220) of the test bench management system, a storage sever external to the test bench management system, or any other suitable type of storage device or repository.

Further, the at least one processor may be configured to continuously (or periodically) monitor the status of the stored/generated one or more test benches, and to perform appropriate operations for managing said one or more test benches. For instance, the at least one processor may continuously (or periodically) monitor status (e.g., version, availability, etc.) of test artifacts associated with said one or more test benches (e.g., by continuously or periodically requesting for the associated information from the one or more nodes via API calls, etc.), and may automatically reconfigure the one or more test benches when required (e.g., based on determining that an associated test artifact(s) has been updated, based on determining that the associated test artifact(s) is no longer available, etc.).

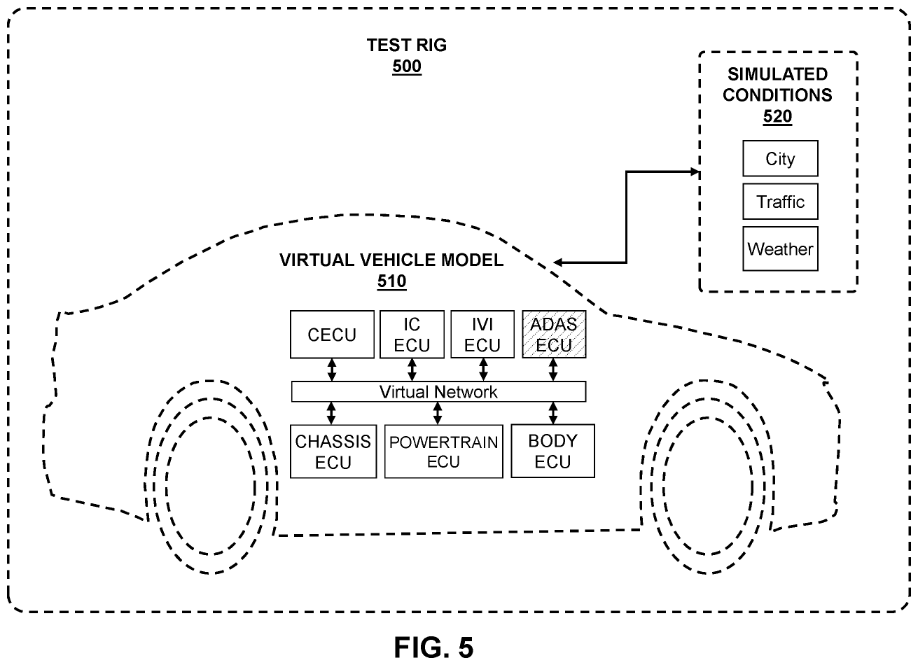

According to embodiments, the at least one processor of the test bench management system may be configured to create a virtual vehicle model based on the generated one or more test benches. The virtual vehicle model may define an end-to-end architecture of a user-intended physical vehicle, wherein the software components (e.g., virtual ECU, emulated ECU, vehicle model, etc.) and the hardware components (e.g., hardware prototype, physical ECU, etc.) may be distributed or located at different geographical locations and may be communicatively coupled to each other via a network. Descriptions of an example of a virtual vehicle model are provided below with reference to FIG. 5.

By creating the virtual vehicle model, a user(s) may deploy one or more software on the virtual vehicle model and perform integration and testing thereon on-demand, regardless of the geographical locations of the user(s) and the components of the virtual vehicle model. In this way, the user may quickly and effectively ensure that the software does not cause regressions and operates as expected, before deploying them on a physical test vehicle and eventually to the customer vehicles.

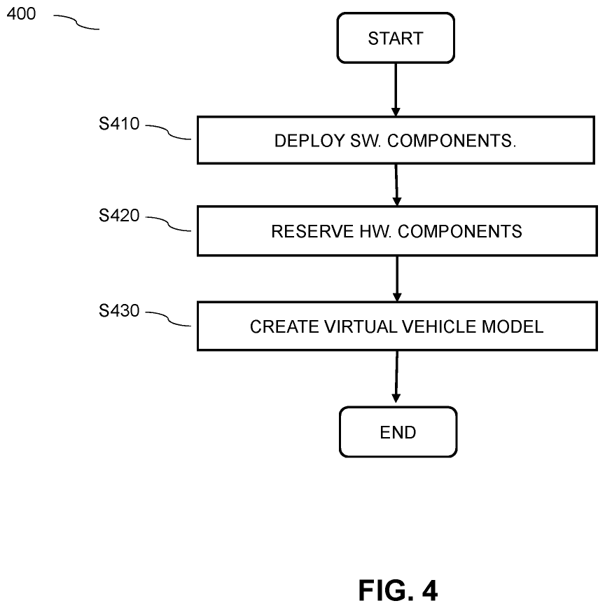

Referring to FIG. 4, which illustrates a flow diagram of an example method 400 for creating a virtual vehicle model, according to one or more embodiments. One or more operations of method 400 may be performed by at least one processor (e.g., processor 230) of the test bench management system of the present disclosure, although it can be understood that said one or more operations may also be performed by any other suitable components of any other suitable system in creating the virtual vehicle model, without departing from the scope of the present disclosure. Further, one or more operations of method 400 may be performed subsequent to one or more operations of method 300 (described above with reference to FIG. 3).

As illustrated in FIG. 4, at operation S410, the at least one processor of the test bench management system may be configured to deploy one or more software components associated with one or more test benches. According to embodiments, the at least one processor may determine, based on one or more test benches (e.g., test benches obtained or generated in a manner described above with reference to FIG. 3, etc.), which software components (e.g., virtualized ECU, emulated ECU, etc.) are defined in the one or more test benches, and may obtain and execute said software components accordingly. For instance, the software components may be deployed in one or more containers, and the at least one processor may obtain said one or more containers and run the instances of the one or more containers.

According to embodiments, the at least one processor may determine, based on the one or more test benches, one or more resource requirements for deploying the one or more software components, may determine, from among a plurality of nodes or equipment communicatively coupled to the test bench management system (e.g., nodes 120-1 to 120-N in FIG. 1, etc.), one or more nodes which satisfy the one or more resource requirements, and may deploy the one or more software components on the determined one or more nodes.

By way of example, the at least one processor may determine, from one or more test benches associated with a virtualized ECU, that execution of a container of the virtualized ECU required a minimal computing power of X and minimal memory of Y. Accordingly, the at least one processor may determine, from among a plurality of nodes (e.g., user devices, equipment, processing servers, etc.) communicatively coupled to the test bench management system, one or more nodes which may provide the minimal computing power X and the minimal memory Y, and may mount the container of the virtualized ECU to the determined one or more equipment. In this way, the at least one processor may dynamically deploy the software components to arbitrary equipment(s) which has the available resources and satisfies the requirement defined in the one or more test benches, regardless of the geographical location(s) at which the equipment are deployed.

Referring still to FIG. 4, at operation S420, the at least one processor of the test bench management system may be configured to reserve one or more hardware components associated with one or more test benches. According to embodiments, the at least one processor may determine, based on the one or more test benches, one or more hardware resource requirements (e.g., which hardware components (e.g., physical ECU, etc.) are defined in the one or more test benches), may determine, from among a plurality of hardware components (e.g., nodes 120-1 to 120-N in FIG. 1, etc.) communicatively coupled to the test bench management system, one or more hardware components which satisfies the one or more hardware resource requirements (e.g., one or more hardware components which are available and satisfy the hardware requirements defined in the one or more test benches), and may reserve the one or more hardware components.

By way of example, the at least one processor may determine, from one or more test benches associated with a virtualized ECU, that the virtualized ECU should be interoperated with a physical ECU in performing a feature. Accordingly, the at least one processor may determine, from among a plurality of physical ECUs communicatively coupled to the test bench management system, at least one physical ECU which satisfies the requirement, and may send a request to the physical ECU for reserving the physical ECU. In this way, the at least one processor may dynamically reserve arbitrary physical ECU(s) which satisfies the requirements defined by the one or more test benches, regardless of the geographical location at which the physical ECU(s) is deployed.

It can be understood that the at least one processor may perform operations S410 and S420 in any suitable sequence. For instance, the at least one processor may perform operation S410 and operation S420 in parallel, may perform operation S420 before performing operation S410, or the like, without departing from the scope of the present disclosure. It can also be understood that, in some implementations, the node(s) at which the software component(s) is deployed may have a software-based test environment (e.g., SIL test environment, etc.) deployed therein, and the hardware component(s) may be communicatively coupled to a hardware-based test environment (e.g., HIL test environment), and said software-based test environment and hardware-based test environment may provide signals or information simulating the operations of the software/hardware component.

Referring still to FIG. 4, at operation S430, the at least one processor of the test bench management system may be configured to create a virtual vehicle model. According to embodiments, the at least one processor may determine, based on the one or more test benches, relationship or connection among the software component(s) and the hardware component(s), and may then connect the software component(s) to the hardware component(s) based on the determined relationship to create the virtual vehicle model thereby.

In some implementations, the at least one processor may connect the software component(s) and the hardware component(s) by: determining, based on the one or more test benches, a vehicle communication specification defining the relationship among the software component(s) and the hardware component(s); generating, based on the vehicle communication specification, a network connection configuration; and providing, to one or more networks (e.g., network 130), the network connection configuration. Accordingly, the one or more networks may be configured to connect, based on the network connection configuration, the software component(s) and the hardware component(s) when required. In some embodiments, the at least one processor may create a virtual network defining the connection among the software component(s) and the hardware component(s) as if they are communicating across an actual vehicle according to the vehicle variant's communication specification.

Upon creating the virtual model(s), the at least one processor of the test bench management system may be configured to utilize the virtual model(s). For instance, the at least one processor may be configured to deploy (or to provide the virtual model(s) to a test management system which may be configured to deploy) one or more software under test to the virtual vehicle model so that a cross-domain test can be performed thereon. As another example, the at least one processor may provide the virtual model(s) to one or more storage mediums (e.g., storage 220, external server, etc.) for storing said virtual model(s) for future use.

According to embodiments, the at least one processor of the test bench management system may be configured to generate, based on the virtual vehicle model, a test rig. In this regard, a test rig described herein may refer to one or more fixtures or components specified to systematically perform a specific testing. In the context of cross-domain testing, the test rig may refer to a specified test environments in which the cross-domain test would be executed.

According to embodiments, the at least one processor of the test bench management system may be configured to generate the test rig by: creating, based on one or more test benches associated with a software (obtained in a similar manner as described above with reference to FIG. 3), a virtual vehicle model (in a similar manner as described above with reference to FIG. 4); determining, based on the one or more test benches, one or more test conditions; and connecting the virtual vehicle model to the one or more test conditions.

The one or more test conditions may be defined by a user(s), and may include traffic condition, weather condition, city condition, and any other suitable type of conditions intended by the user(s) for testing the software. In some implementations, the at least one processor may be further configured to generate the test rig, taken into consideration of one or more test objectives (e.g., target testing runtime, target testing result, etc.) defined by the user(s). In this regard, it can be understood that the parameters defined by the user(s), such as said one or more test conditions and/or said one or more test objectives, may be appropriately obtained by the at least one processor (e.g., obtain from user device in real-time or near real-time, obtain from one or more storage mediums, etc.).

Referring to FIG. 5, which illustrates a block diagram of an example test rig 500, according to one or more embodiments. The test rig 500 may be generated by the at least one processor of the test bench management system, as well as any other suitable system which may utilize the one or more test benches provided by the test bench management system. In this example use case, it is assumed that the test rig 500 is generated for performing a cross-domain test, with an Advanced Driver Assistance Systems (ADAS) ECU as the target software to be tested.

As illustrated in FIG. 5, the test rig 500 may include a virtual vehicle model 510 and a plurality of simulated conditions 520, although it can be understood that the test rig 500 may further comprise any other suitable components and/or may be arranged in a manner different from as illustrated in FIG. 5.

In this example use case, the virtual vehicle model 510 includes a plurality of software components, such as at least one Central ECU (CECU), at least one instrument cluster (IC) ECU, at least one In-Vehicle Infotainment (IVI) ECU, at least one ADAS ECU (i.e., the target software to-be tested in this example use case), and a plurality of hardware components, such as at least one Chassis ECU, at least one Powertrain ECU, and at least one Body ECU. The plurality of software components are communicatively coupled to the plurality of hardware components via a virtual network, such that they may interoperate with each other in a similar manner as if they are communicating across a physical vehicle.

It can be understood that, in other implementations, one or more of said Central ECU, IC ECU, and IVI ECU may be physical and hardware-based, and/or one or more of said Chassis ECU, Powertrain ECU, and Body ECU may be virtual and software-based. Further, it can also be understood that the virtual vehicle model 510 may include one or more additional components, such as one or more vehicle models (e.g., DCM model, HVAC model, etc.), one or more vehicle parameters (e.g., vehicle variant, etc.), or any other suitable component(s) for further simulating the virtual vehicle model to be more realistic towards a target vehicle.

Further, in the example use case of FIG. 5, the plurality of simulated conditions 520 includes city condition, traffic condition, and weather condition, although it can be understood that the plurality of simulated conditions 520 may include any other suitable type of condition(s) which intended by the user(s) for specifying the virtual surrounding environment of the virtual vehicle model.

In view of the above, the test bench management system of example embodiments may automatically create one or more test rigs based on the user-defined test requirements and test conditions, and may then perform a cross-domain test for testing a target software based on the created test rig(s).

Further, the user(s) may easily reconfigure the cross-domain test by, for example, providing to the test bench management system a reconfigured version (e.g., updated version, different version, etc.) of target software, adding/removing one or more test conditions, or the like, and the test bench management system may automatically update the test bench(s) associated with the target software to thereby update the associated test rig(s), in real-time or near real-time.

Furthermore, the test bench management system may continuously (or periodically) monitor the availability of the software resources and hardware resources, and may automatically reconfigure the test rig(s) based on determining that the currently utilized software resources and/or hardware resources are no longer optimal. For instance, based on determining that another device which can deploy the software component(s) and can provide better performance (e.g., higher computing power, etc.) is available, the test bench management system may redeploy the software component(s) to said another device. As another example, based on determining that a hardware component(s) is no longer available (e.g., due to unanticipated hardware issue, etc.) or that the hardware component will be soon unavailable (e.g., due to reservation by other user, etc.), the test bench management system may search for another available hardware component(s) which fulfills the requirements defined in the test bench(s) and reserve said another hardware component(s). In this way, the test bench management system may automatically reconfigure the test rig(s) based on the real-time or near real-time resource conditions, to thereby ensure that the cross-domain test can be performed without interruption.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method, implemented by at least one processor of a system, for managing a test bench for a cross-domain test for testing software of an embedded system, the method comprising:
obtaining a test bench configuration associated with the software,
obtaining information of a plurality of test artifacts associated with the test bench configuration; and
generating, based on the plurality of test artifacts, a test bench associated with the cross-domain test,
wherein the software of the embedded system comprises an in-vehicle electronic control unit (ECU).

2. The method according to claim 1, wherein the obtaining the test bench configuration comprises:
receiving, from a user, one or more inputs defining the test bench;
obtaining a components catalog including information of available test artifacts;
determining, based on the one or more inputs and from among the available test artifacts, one or more test artifacts associated with the user-defined test bench; and
building, based on the determined one or more test artifacts, the test bench configuration.

3. The method according to claim 1, wherein the plurality of test artifacts comprises at least one software component, at least one hardware component, or a combination thereof.

4. The method according to claim 1, wherein at least a portion of the plurality of test artifacts is deployed at different geographical locations.

5. The method according to claim 3, wherein the at least one software component comprises at least one virtual ECU, at least one emulated ECU, or a vehicle-related model; and
wherein the at least one hardware component comprises at least one physical ECU.

6. The method according to claim 3, further comprising:
deploying, based on the test bench, the at least one software component;
reserving, based on the test bench, the at least one hardware component; and
creating, based on the at least one software component and the at least one hardware component, a virtual vehicle model.

7. The method according to claim 6, wherein the deploying the at least one software component comprises:
determining, based on the test bench, at least one resource requirement for deploying the at least one software component;
determining, from among a plurality of nodes communicatively coupled to the system, at least one node which satisfies the at least one resource requirement; and
deploying the at least one software component on the determined at least one node.

8. The method according to claim 6, wherein the reserving the at least one hardware component comprises:
determining, based on the test bench, at least one hardware resource requirement;
determining, from among a plurality of hardware components communicatively coupled to the system, the at least one hardware component, wherein the at least one hardware component satisfies the at least one hardware resource requirement; and
reserving the at least one hardware component.

9. The method according to claim 6, wherein the creating the virtual vehicle model comprises:
determining, based on the test bench, a relationship among the at least one software component and the at least one hardware component; and
connecting, based on the determined relationship, the at least one software component to the at least one hardware component.

10. The method according to claim 6, further comprising generating, based on the virtual vehicle model, a test rig for the cross-domain test.

11. A system for managing a test bench for a cross-domain test for testing software of an embedded system, the system comprising:
at least one memory storage storing computer-executable instructions; and
at least one processor communicatively coupled to the at least one memory storage and configured to execute the computer-executable instructions to:
obtain a test bench configuration associated with the software;
obtain information of a plurality of test artifacts associated with the test bench configuration; and
generate, based on the plurality of test artifacts, a test bench associated with the cross-domain test,
wherein the software of the embedded system comprises an in-vehicle electronic control unit (ECU).

12. The system according to claim 11, wherein the at least one processor is configured to execute the computer-executable instructions to obtain the test bench configuration by:
receiving, from a user, one or more inputs defining the test bench;
obtaining a components catalog including information of available test artifacts;
determining, based on the one or more inputs and from among the available test artifacts, one or more test artifacts associated with the user-defined test bench; and
building, based on the determined one or more test artifacts, the test bench configuration.

13. The system according to claim 11, wherein the plurality of test artifacts comprises at least one software component, at least one hardware component, or a combination thereof.

14. The system according to claim 11, wherein at least a portion of the plurality of test artifacts is deployed at different geographical locations.

15. The system according to claim 13, wherein the at least one software component comprises at least one virtual ECU, at least one emulated ECU, or a vehicle-related model; and wherein the at least one hardware component comprises at least one physical ECU.

16. The system according to claim 13, wherein the at least one processor is further configured to execute the computer-executable instructions to:
deploy, based on the test bench, the at least one software component;
reserve, based on the test bench, the at least one hardware component; and
create, based on the at least one software component and the at least one hardware component, a virtual vehicle model.

17. The system according to claim 16, wherein the at least one processor is configured to execute the computer-executable instructions to deploy the at least one software component by:
determining, based on the test bench, at least one resource requirement for deploying the at least one software component;
determining, from among a plurality of nodes communicatively coupled to the system, at least one node which satisfies the at least one resource requirement; and
deploying the at least one software component on the determined at least one node.

18. The system according to claim 16, wherein the at least one processor is configured to execute the computer-executable instructions to reserve the at least one hardware component by:
determining, based on the test bench, at least one hardware resource requirement;
determining, from among a plurality of hardware components communicatively coupled to the system, the at least one hardware component, wherein the at least one hardware component satisfies the at least one hardware resource requirement; and
reserving the at least one hardware component.

19. The system according to claim 16, wherein the at least one processor is configured to execute the computer-executable instructions to create the virtual vehicle model by:
determining, based on the test bench, a relationship among the at least one software component and the at least one hardware component; and
connecting, based on the determined relationship, the at least one software component to the at least one hardware component.

20. The system according to claim 16, wherein the at least one processor is further configured to execute the computer-executable instructions to generate, based on the virtual vehicle model, a test rig for the cross-domain test.
